(19) United States
(12) Patent Application Publication
(10) Pub. No.: US 2020/0086476 A1
(43) Pub. Date: Mar. 19, 2020

(54) POSITIONING PAD FOR TOOLS

(71) Applicant: ERSSON CO., LTD., Taichung City (TW)

(72) Inventor: Ming-Hsien Liu, Taichung City (TW)

(21) Appl. No.: 16/134,143

(22) Filed: Sep. 18, 2018

(51) Int. Cl. B25H 3/00

(52) U.S. Cl. CPC B25H 3/003

(57) ABSTRACT

A positioning pad has a pad body and a coat layer. The pad body is made of a foaming material, is formed as a board, and has at least one tool recess defined in a top of the pad body. The coat layer is attached to the top of the pad body and has at least one window and a 3D (three dimensional) embossing pattern. The at least one window is defined through the coat layer and corresponds respectively to the at least one tool recess in the pad body in position and shape. The 3D embossing pattern is formed on a top of the coat layer and has multiple embossing units. Each embossing unit has an outer frame and a decorating surface enclosed by the outer frame.

### BACKGROUND OF THE INVENTION

### 1. Field of the Invention

The present invention relates to a positioning pad, and more particularly to a positioning pad for tools to hold the tools in position.

### 2. Description of Related Art

To hold tools and tool accessories in position, conventional positioning pads for tools are provided as TW M394216, TW M503986 or TW M558177. The conventional positioning pad is made of a foaming material, such as Ethylene Vinyl Acetate (EVA) or Polyurethane (PU), is formed as a board and is cut into a desired size. A decorating layer made of a plastic sheet or fabric is attached to a top of the positioning pad. Multiple tool recesses are defined in the top of the positioning pad to hold tools in different shapes or sizes inside. Because the foaming material is flexible, tools and tool accessories can be held in the tool recesses firmly.

However, the decorating layer of the conventional positioning pad can only provide a 2D (two dimensional) visual effect by the color or figure in the plastic sheet or fabric. Thus, the conventional positioning pad cannot provide a 3D (three dimensional) visual effect, so the conventional positioning pad is not versatile and aesthetic in appearance. In addition, the 2D surface design of the conventional positioning pad cannot provide a non-slipping effect.

To overcome the shortcomings, the present invention tends to provide a positioning pad for tools to mitigate or obviate the aforementioned problems.

### SUMMARY OF THE INVENTION

The main objective of the invention is to provide a positioning pad that has 3D patterns to improve visual effect of the positioning pad.

The positioning pad has a pad body and a coat layer. The pad body is made of a foaming material, is formed as a board, and has at least one tool recess defined in a top of the pad body. The coat layer is attached to the top of the pad body and has at least one window and a 3D (three dimensional) embossing pattern. The at least one window is defined through the coat layer and corresponds respectively to the at least one tool recess in the pad body in position and shape. The 3D embossing pattern is formed on a top of the coat layer and has multiple embossing units. Each embossing unit has an outer frame and a decorating surface enclosed by the outer frame.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a positioning pad in accordance with the present invention;

FIG. 2 is an enlarged cross sectional side view of the positioning pad in

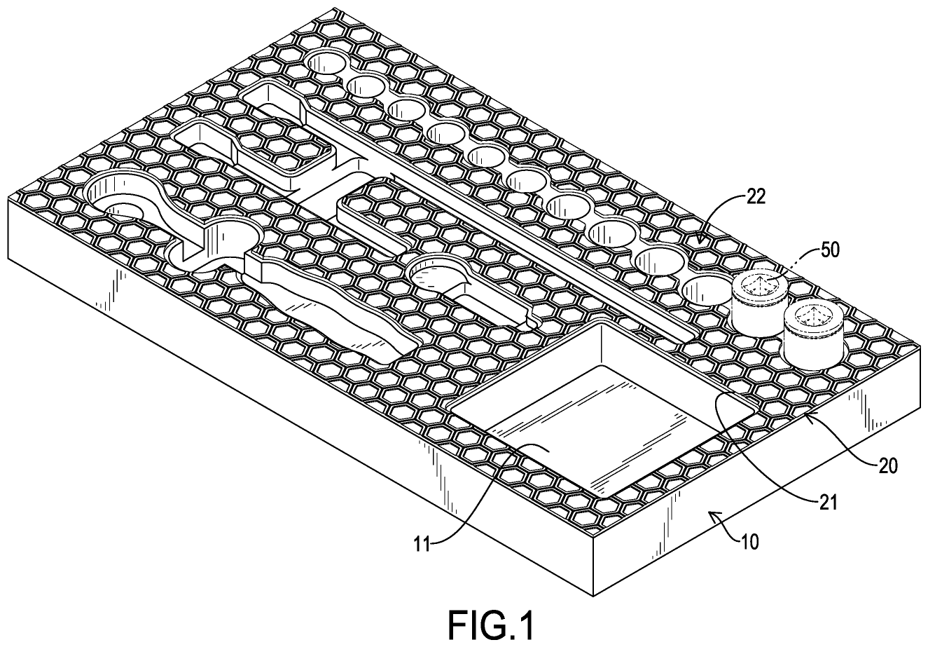

FIG. 1;

FIG. 3 is an enlarged cross sectional perspective view of the positioning pad in FIG. 1;

FIG. 3A is an enlarged perspective view of the positioning pad in FIG. 3;

FIG. 4 is a perspective view of a second embodiment of a positioning pad in accordance with the present invention;

FIG. 4A is an enlarged perspective view of the positioning pad in FIG. 4;

FIG. 5 is an enlarged cross sectional side view of the positioning pad in

FIG. 4;

FIG. 6 is a top view of a third embodiment of a positioning pad in accordance with the present invention;

FIG. 7 is a top view of a fourth embodiment of a positioning pad in accordance with the present invention;

FIG. 8 is a top view of a fifth embodiment of a positioning pad in accordance with the present invention;

FIG. 9 is a top view of a sixth embodiment of a positioning pad in accordance with the present invention;

FIG. 10 is an enlarged cross sectional side view of the positioning pad in

FIG. 9;

FIG. 11 is an enlarged top view of the positioning pad in FIG. 9;

FIG. 12 is an enlarged perspective view of the embossing unit of the positioning pad in FIG. 9;

FIG. 13 is an enlarged perspective view of an embossing unit of a seventh embodiment of a positioning pad in accordance with the present invention;

FIG. 14 is a top view of an eighth embodiment of a positioning pad in accordance with the present invention;

FIG. 15 is an enlarged perspective view of the embossing unit of the positioning pad in FIG. 14;

FIG. 16 is an enlarged perspective view of an embossing unit of a ninth embodiment of a positioning pad in accordance with the present invention;

FIG. 17 is a top view of a tenth embodiment of a positioning pad in accordance with the present invention; and

FIG. 18 is a top view of an eleventh embodiment of a positioning pad in accordance with the present invention.

### DETAILED DESCRIPTION OF PREFERRED EMBODIMENT

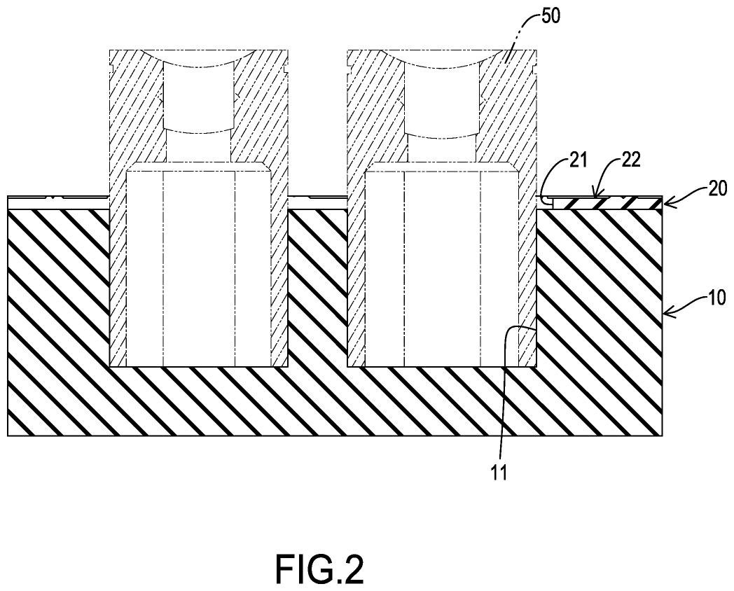

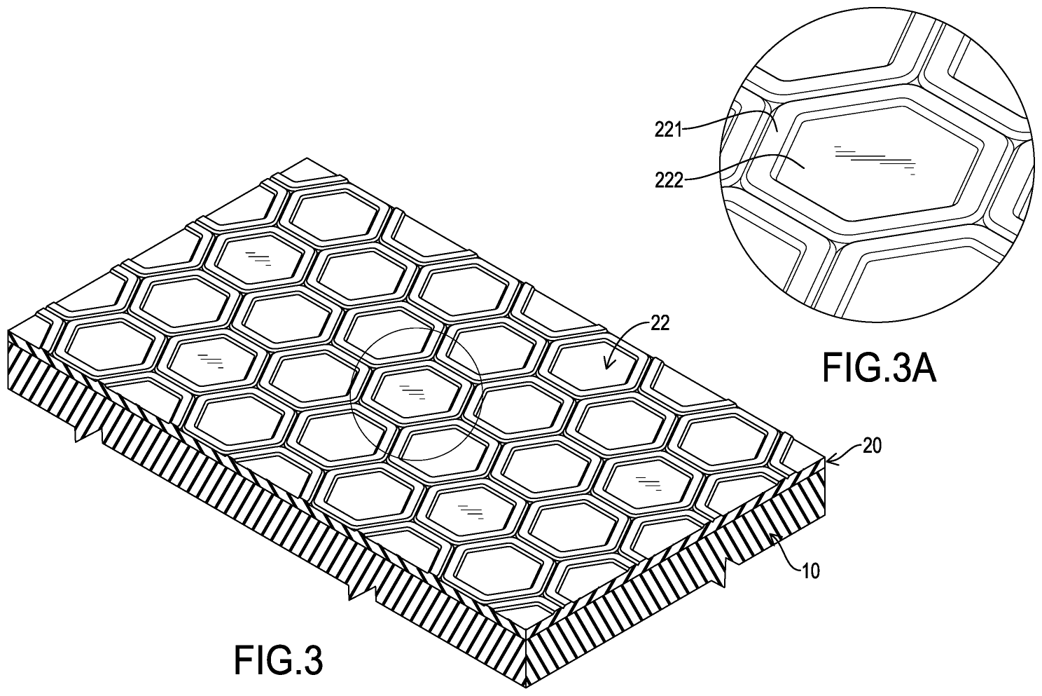

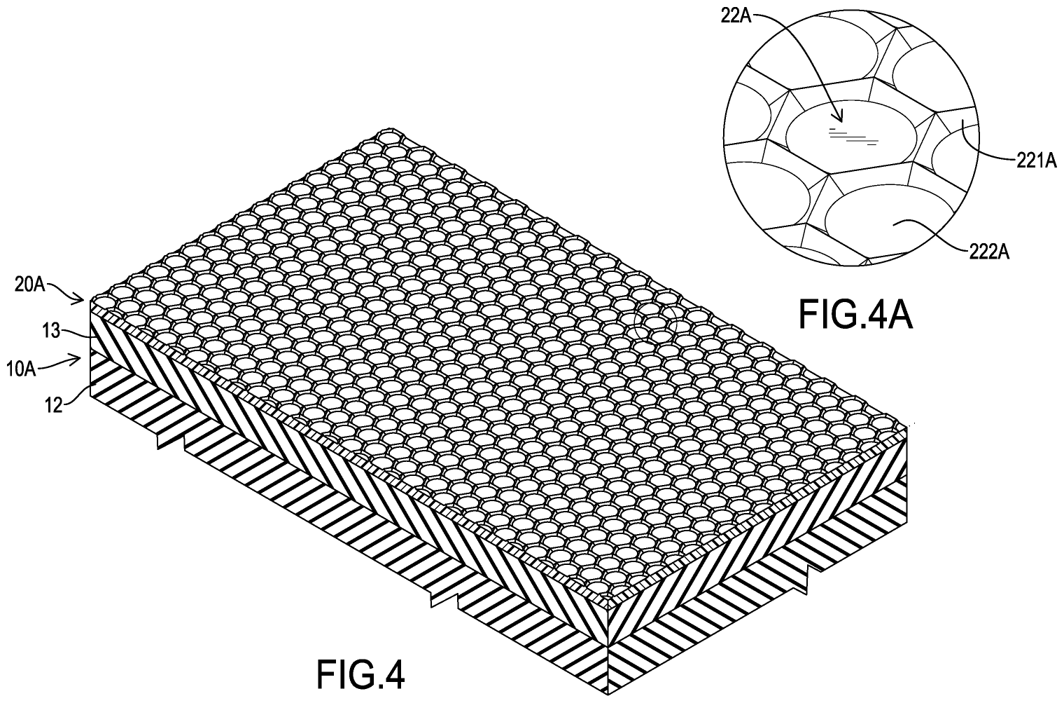

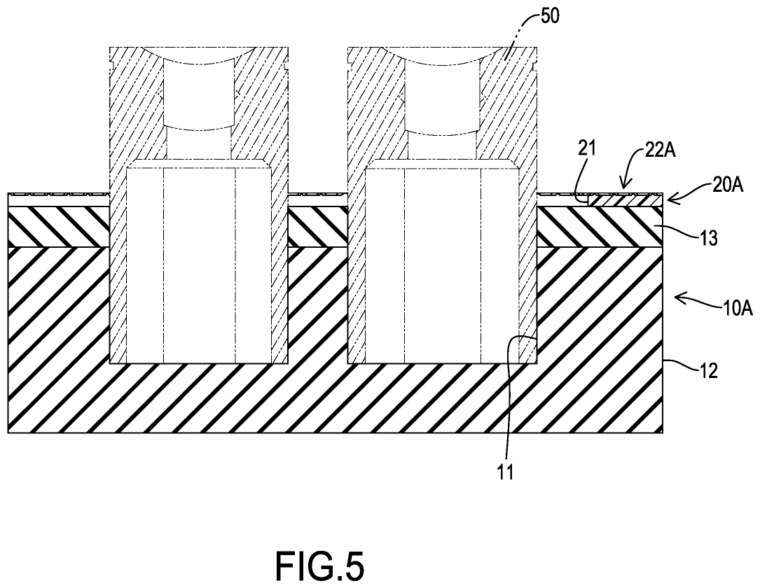

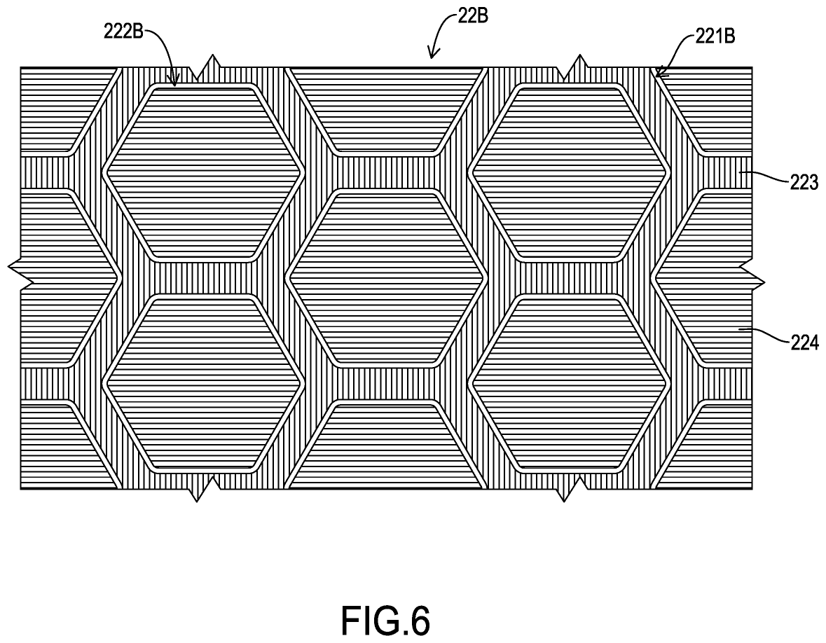

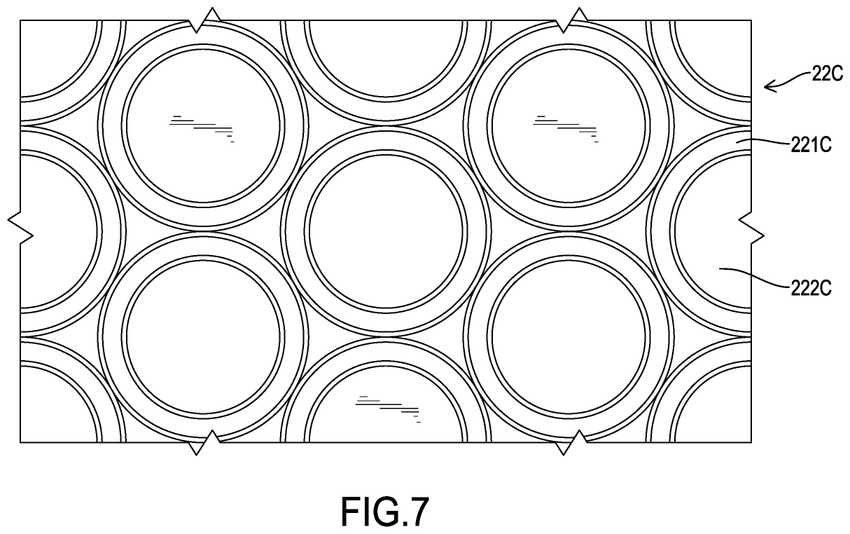

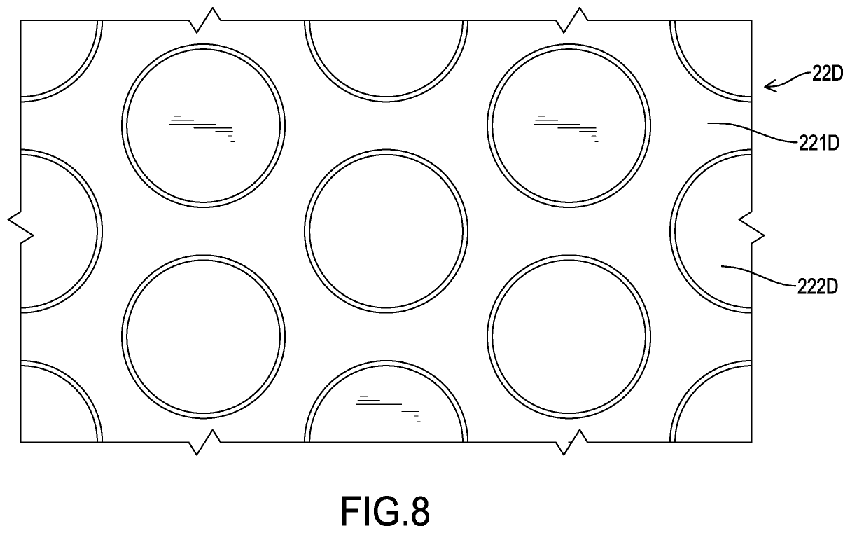

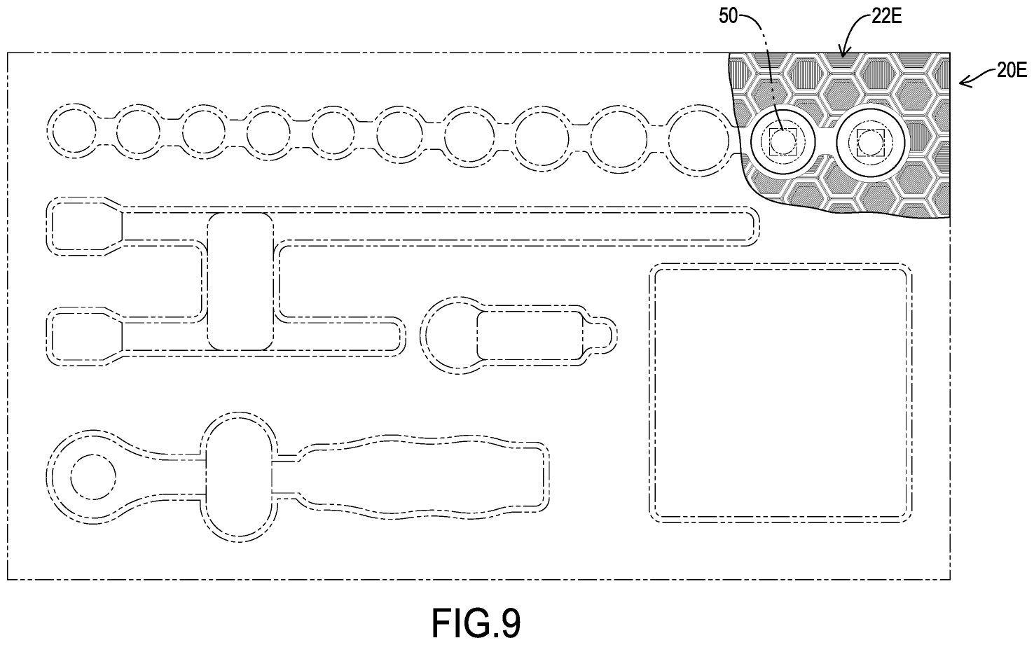

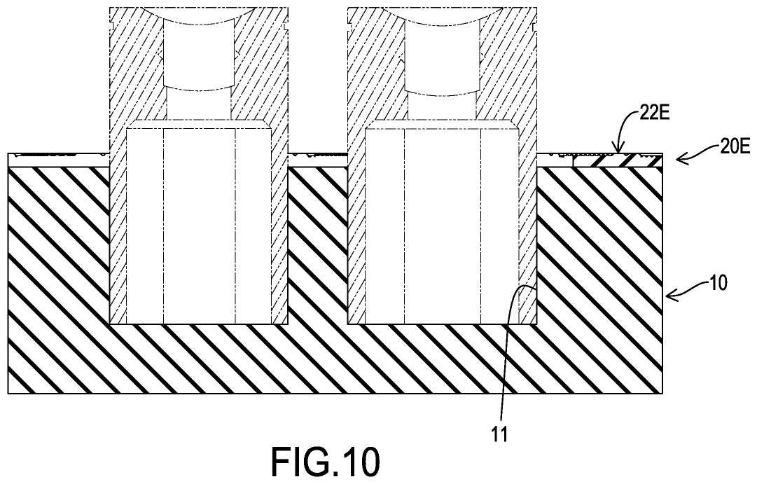

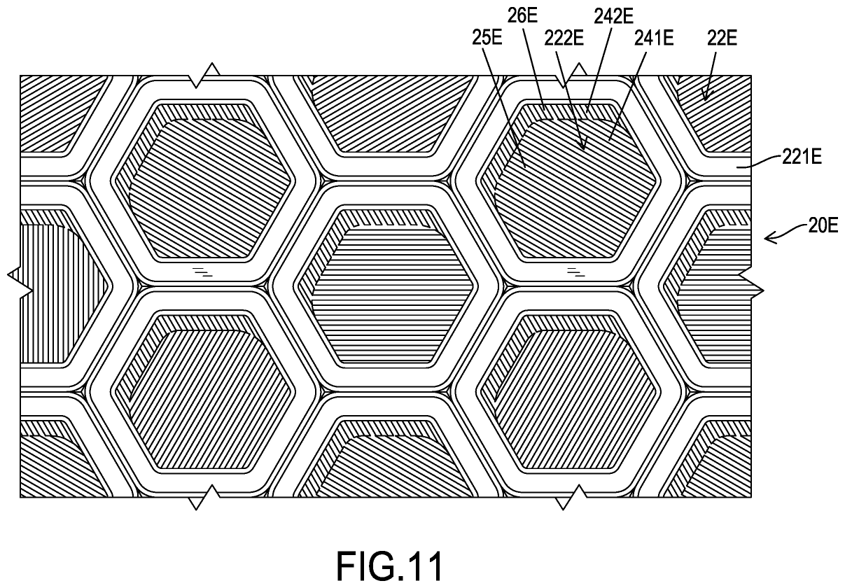

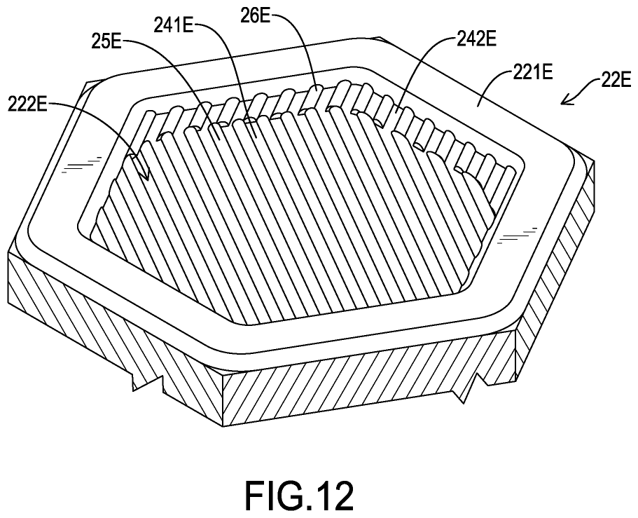

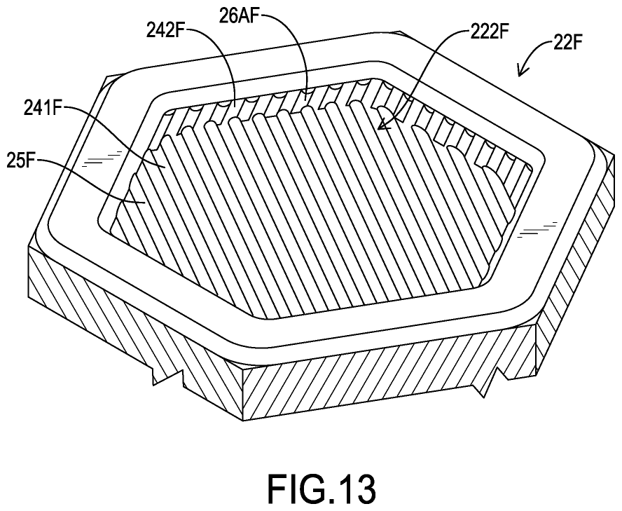

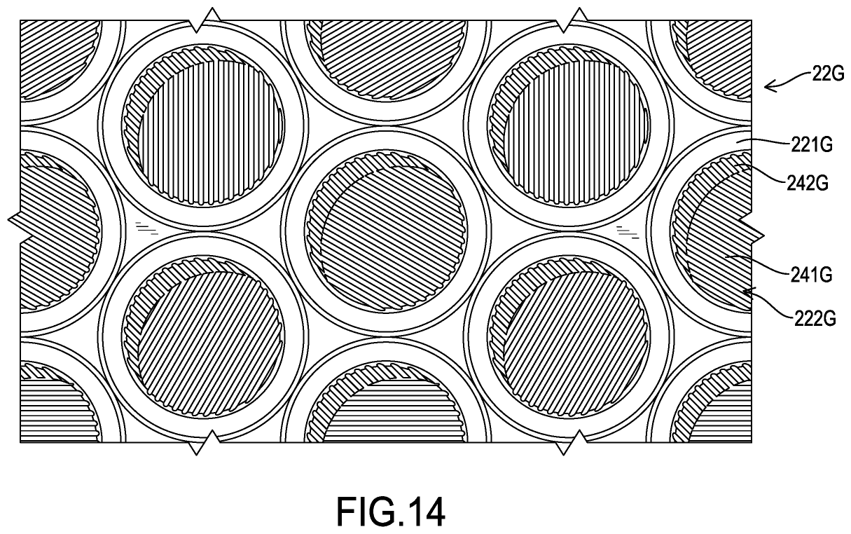

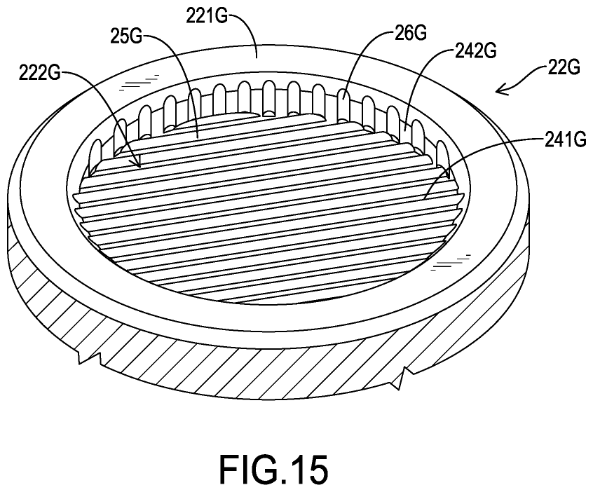

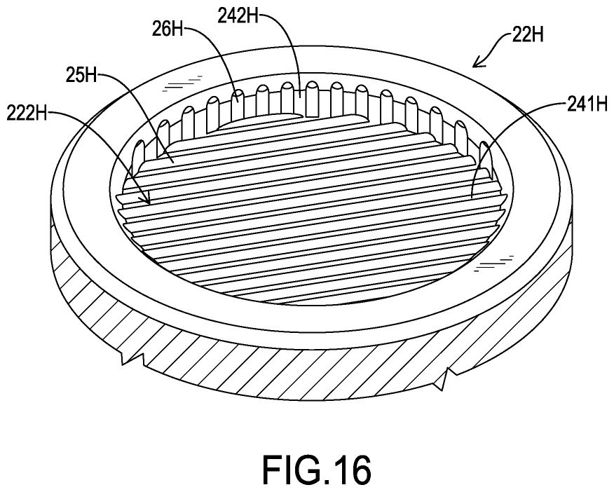

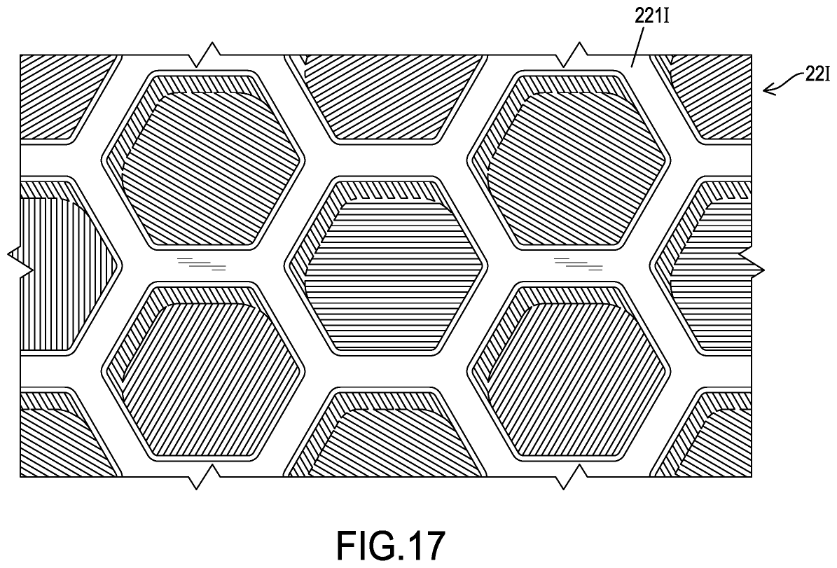

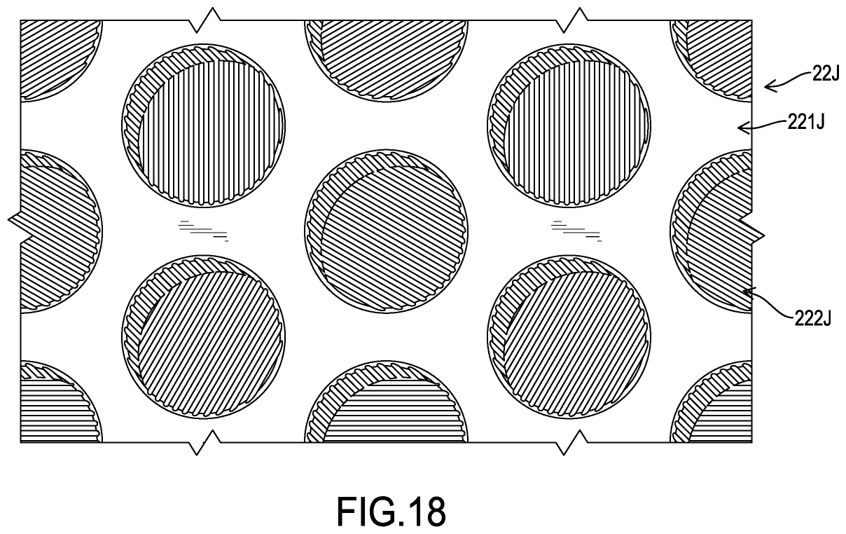

With reference to FIGS. 1 to 3, a positioning pad for tools in accordance with the present invention comprises a pad body 10 and a coat layer 20. The pad body 10 is made of a foaming material, such as EVA or PU, and is formed as a board having a predetermined thickness. The pad body 10 has multiple tool recesses 11 defined in a top of the pad body 10 to hold tools 50 or tool accessories respectively in the tool recesses 11. The material, the size, the dimensions, and the shape of the pad body 10 and the amount of the tool recesses 11 are not limited in the present invention.

The coat layer 20 is attached to the top of the pad body 10 and may be made of artificial or nature leather or a plastic sheet that is flexible and extendable. The coat layer 20 has multiple windows 21 defined through the coat layer 20 and corresponding respectively to the tool recesses 11 in the pad body 10 in position and shape. The coat layer 20 further has a 3D (three dimensional) embossing pattern formed on a top of the coat layer 20.

In the first embodiment, the 3D embossing pattern comprises multiple embossing units 22. Each embossing unit 22 comprises a hexagonal outer frame 221 and a hexagonal decorating surface 222 enclosed by the hexagonal outer frame 221. With the arrangement of the outer frame 221 and the decorating surface 222, each embossing unit 22 has a height difference to show a 3D visual effect. Accordingly, the appearance of the positioning pad shows variations between light and shade, and an anti-slipping effect is provided.

With reference to FIGS. 4, 4A, and 5, in the second embodiment, the pad body 10A comprises a base segment 12 and a surface segment 13. The base segment 12 has a color. The surface segment 13 is mounted on a top of the base segment 12 and has a color different from the color of the base segment 12. The coat layer 20A is attached to a top of the surface segment 13. With such an arrangement, the color of the surface segment 13 can be shown from the windows 21 in the coat layer 20A, such that the positioning pad in accordance with the present invention has a colorful decorative effect. Each embossing unit 22A in the second embodiment comprises a hexagonal outer frame 221A and a hexagonal decorating surface 222A enclosed by the hexagonal outer frame 221A to form a 3D embossing pattern.

With reference to FIG. 6, in the third embodiment, the outer frames 221B of the embossing units 22B are connected with each other to form a honeycomb structure. The outer frame 221B of each embossing unit 22B has multiple embossing lines 223 extending along a first direction, and the decorating surface 222B of each embossing unit 22B has multiple embossing lines 224 extending along a second direction. The first direction is non-parallel with the second direction, such that the appearance of the 3D embossing pattern shows variations between light and shade.

With reference to FIG. 7, the outer frame 221C and the decorating surface 222C of each embossing unit 22C are round in shape. With reference to FIG. 8, in the fifth embodiment, the outer frames 221D of the embossing units 22D are connected with each other, and the decorating surface 222D of each embossing unit 22D is round in shape.

With reference to FIGS. 9 to 11, in the sixth embodiment, the outer frame 221E and the decorating surface 222E of each embossing unit 22E on the coat layer 20E are hexagonal in shape. The decorating surface 222E of each embossing unit 22E is divided into a main segment 241E and a minor segment 242E arranged on a side of the main segment 241E. The minor segment 242E has an area smaller than an area of the main segment 241E. The main segment 241E has multiple embossing lines 25E extending along a first direction. The minor segment 242E has multiple embossing lines 26E extending along a second direction. The second direction of the embossing lines 26E is non-parallel with the first direction of the embossing lines 25E. Consequently, a curved boarding line is formed between the main segment 241E and the minor segment 242E. Accordingly, the minor segment 242E can show a visual effect of shadowing.

With reference to FIGS. 11 and 12, with the non-parallel embossing lines 25E, 26E in the main segment 241E and the minor segment 242E of each embossing unit 22E, the main segment 241E and the minor segment 242E have different reflective effects. In addition, the embossing lines 25E, 26E in the main segment 241E and the minor segment 242E may be protruding lines or recessed lines. In the sixth embodiment as shown in FIG. 12, the embossing lines 25E, 26E in the main segment 241E and the minor segment 242E are all protruding lines. In the seventh embodiment as shown in FIG. 13, the embossing lines 25F in the main segment 241F of the decorating surface 222F of each embossing unit 22F are protruding lines, and the embossing lines 26F in the minor segment 242F of the decorating surface 222F of each embossing unit 22F are recessed lines.

With reference to FIGS. 9, 11, and 12, the outer frames 221E and the decorating surfaces 222E of the embossing units 22E have height differences and the embossing lines 25E, 26E in the main segments 241E and the minor segments 242E have different reflective effects. In addition, the minor segments 242E have a visual effect of shadowing. Consequently, the positioning pad in accordance with the present invention has a decorative visual effect of light and shadow changes, and the appearance of the positioning pad shows variations and is aesthetic.

With reference to FIGS. 14 and 15, in the eighth embodiment, the outer frame 221G and the decorating surface 222 G of each embossing unit 22 G of the 3D embossing pattern are round in shape. The embossing lines 25 G, 26 G in the main segment 241 G and the minor segment 242 G are all protruding lines. With reference to FIG. 16, in the ninth embodiment, the embossing lines 25H of the main segment 241H of the decorating surface 222H of each embossing unit 22H are protruding lines. The embossing lines 26H of the main segment 242H of the decorating surface 222H of each embossing unit 22H are recessed lines.

With reference to FIG. 17, in the tenth embodiment, the outer frames 2211 of the embossing units 221 are connected with each other to form a honeycomb structure. With reference to FIG. 18, in the eleventh embodiment, the outer frames 221J of the embossing unit 22J are connected with each other, and the decorating surface 222J of each embossing unit 22J is round in shape.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A positioning pad for tools comprising:
a pad body made of a foaming material, formed as a board, and having at least one tool recess defined in a top of the pad body; and
a coat layer attached to the top of the pad body and having
at least one window defined through the coat layer and corresponding respectively to the at least one tool recess in the pad body in position and shape; and
a 3D (three dimensional) embossing pattern formed on a top of the coat layer and comprising multiple embossing units, and each embossing unit comprising an outer frame and a decorating surface enclosed by the outer frame.

2. The positioning pad as claimed in claim 1, wherein the coat layer is made of leather or a plastic sheet.

3. The positioning pad as claimed in claim 2, wherein
the pad body comprises
a base segment having a color; and
a surface segment mounted on a top of the base segment and having a color different from the color of the base segment; and
the coat layer is attached to a top of the surface segment.

4. The positioning pad as claimed in claim 3, wherein the decorating surface of each embossing unit has multiple embossing lines.

5. The positioning pad as claimed in claim 4, wherein
the decorating surface of each embossing unit is divided into a main segment and a minor segment arranged on a side of the main segment and having an area smaller than an area of the main segment;
the embossing lines in the main segment of each embossing unit extend along a first direction, and the embossing lines in the minor segment of the embossing unit extend along a second direction being non-parallel with the first direction.

6. The positioning pad as claimed in claim 5, wherein the embossing lines in the main segment of each embossing unit are protruding lines.

7. The positioning pad as claimed in claim 6, wherein the embossing lines in the minor segment of each embossing unit are recessed lines.

8. The positioning pad as claimed in claim 7, wherein the outer frame and the decorating surface of each embossing unit are hexagonal in shape.

9. The positioning pad as claimed in claim 7, wherein the outer frame and the decorating surface of each embossing unit are round in shape.

10. The positioning pad as claimed in claim 5, wherein the embossing lines in the main segment of each embossing unit are recessed lines.

11. The positioning pad as claimed in claim 10, wherein the embossing lines in the minor segment of each embossing unit are protruding lines.

12. The positioning pad as claimed in claim 11, wherein the outer frame and the decorating surface of each embossing unit are hexagonal in shape.

13. The positioning pad as claimed in claim 11, wherein the outer frame and the decorating surface of each embossing unit are round in shape.

14. The positioning pad as claimed in claim 1, wherein
the pad body comprises
a base segment having a color; and
a surface segment mounted on a top of the base segment and having a color different from the color of the base segment; and
the coat layer is attached to a top of the surface segment.

15. The positioning pad as claimed in claim 1, wherein the decorating surface of each embossing unit has multiple embossing lines.

16. The positioning pad as claimed in claim 15, wherein
the decorating surface of each embossing unit is divided into a main segment and a minor segment arranged on a side of the main segment and having an area smaller than an area of the main segment;
the embossing lines in the main segment of each embossing unit extend along a first direction, and the embossing lines in the minor segment of the embossing unit extend along a second direction being non-parallel with the first direction.

17. The positioning pad as claimed in claim 16, wherein the embossing lines in the main segment of each embossing unit are protruding lines.

18. The positioning pad as claimed in claim 17, wherein the embossing lines in the minor segment of each embossing unit are recessed lines.

19. The positioning pad as claimed in claim 1, wherein the outer frame and the decorating surface of each embossing unit are hexagonal in shape.

20. The positioning pad as claimed in claim 1, wherein the outer frame and the decorating surface of each embossing unit are round in shape.
